(19) United States
(12) Patent Application Publication
(10) Pub. No.: US 2007/0260514 A1
(43) Pub. Date: Nov. 8, 2007

(54) Distributed architecture for online advertising

(75) Inventors: Brian Burdick, Bellevue, WA (US); Christopher A. Meek, Kirkland, WA (US); David M. Chickering, Bellevue, WA (US); Ewa Dominowska, Kirkland, WA (US); Jody D. Biggs, Redmond, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/418,905

(22) Filed: May 5, 2006

(51) Int. Cl. G06Q 30/00

(52) U.S. Cl. 705/14

(57) ABSTRACT

A system to facilitate trading of advertising comprises a publisher broker representing at least one publisher and to determine an ask for an advertisement space on the publisher's webpage, an advertiser broker representing at least one advertiser and to manage an advertiser's bid for the advertisement space, and an exchange to facilitate a transaction for the advertisement space between the publisher broker and the advertiser broker. A method of facilitating trading of advertising comprises receiving an ask from a publisher broker for advertisement space on a webpage, receiving a bid from an advertiser broker for the advertisement space, and pairing the ask with the bid. A method for enriching user information comprises aggregating user information about a user, storing the aggregate user information according to a user identifier, receiving the user identifier from an exchange, and sending the aggregate user information to the exchange.

### CROSS-REFERENCE TO RELATED APPLICATIONS

The contents of the patent application entitled “Publisher Unions,” filed on the same day herewith, are incorporated herein by reference.

### STATEMENT REGARDING FEDERALLY SPONSORED RESEARCH OR DEVELOPMENT

Not applicable.

### BACKGROUND

Historically, large web search engines have sold advertising space based on keyword-driven search results. For example, Yahoo! conducts auctions for certain keywords, and the highest bidder(s) have their ads placed on pages containing Yahoo! search results, or they obtain preferred placement among the search results, i.e., at the top of the results list.

As web advertising develops, a number of companies are now acquiring large publisher bases from which they can sell advertisements. Specifically, Google is signing up publishers into their AdSense ad network. Advertisers pay Google to serve advertisements to participants of the AdSense network. Google then pays some or all of the advertising revenue to the individual publishers. For example, a publisher in the AdSense network may have an article on its website that talks about digital cameras, and Google's AdSense would display digital camera advertisements from advertisers in the AdSense network on that website. Google would auction off the “digital camera” keyword to advertisers in its AdSense network and display ads from the highest bidder(s).

There are a number of problems with this proprietary ad network model. First, companies that are building ad networks have an inherent conflict of interest because they represent both the publisher and the advertiser. Second, because there are multiple companies that are creating ad networks, advertisers have the burden of managing buys across many ad networks, which results in significant cost and complexity to the advertiser. Third, because publishers are for all practical purposes locked into a single ad network, the advertiser competition is limited, which results in lower return for the publishers. Fourth, the lack of general standards around terms and conditions, and behavioral segmentation is a major obstacle to reaching the full market value of online display advertising. There is also no current standardization across publishers for accepted media types and ad formats. Fifth, smaller publishers currently have very little power individually, even if they serve a hard-to-reach audience. Finally, ISPs and other owners of large user databases are not realizing the full value of the information they have due to privacy concerns and lack of a proper marketplace.

### SUMMARY

A distributed architecture for online advertising is a market mechanism that manages the exchange of goods between three participants. A user requests a page impression from a publisher who is represented by a publisher broker. The publisher broker can set an ask for any advertisement space on that page and will post to an exchange those asks, along with any other information from the publisher (e.g., important words on the page, the channel on which the page belongs, etc.). The exchange reads audience data broker identifiers directly from the user, and sends those to the appropriate audience data brokers. When the audience data brokers receive the user identifier, they can choose to provide their information about the user. The audience broker sets an ask on the usage of user data by the advertiser. The advertiser brokers receive the impression information along with whatever user data has been provided from those audience data brokers they are licensing from, and posts corresponding bids. The exchange then matches the asks with the bids, and the appropriate advertisements are placed on the page that is returned to the user.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE SEVERAL VIEWS OF THE DRAWINGS

The present invention is described in detail below with reference to the attached drawing figures, wherein:

FIG. 1 is a block diagram of a computing system environment suitable for use in implementing the present invention;

FIG. 2 illustrates a distributed architecture for online advertising, according to embodiments of the present invention;

FIG. 3 illustrates one example of the flow of data within architecture 200, according to embodiments of the present invention;

FIG. 4 illustrates a flowchart of the operation of an exchange, according to embodiments of the present invention; and

FIG. 5 illustrates a flowchart of the operation of an audience data broker, according to embodiments of the present invention.

### DETAILED DESCRIPTION

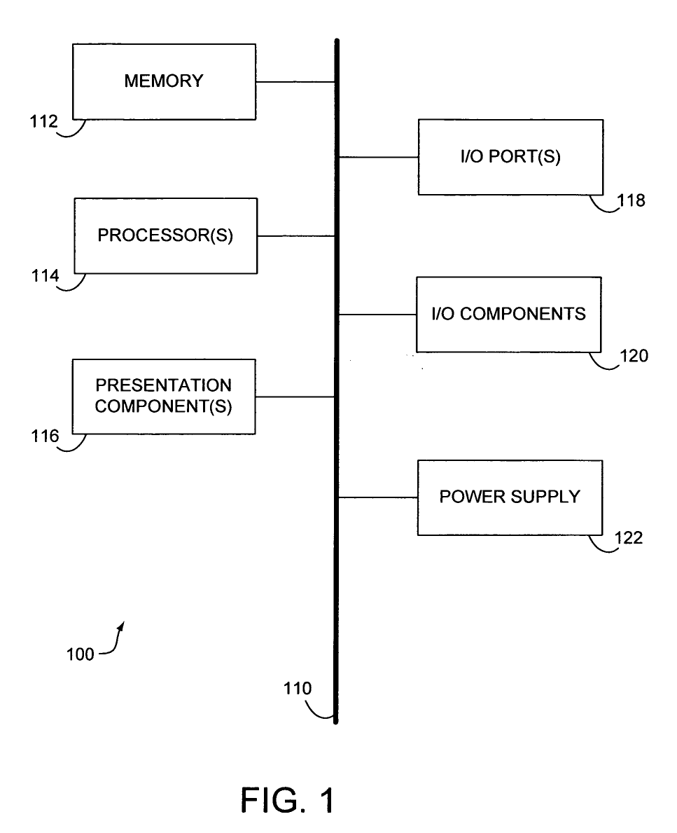

Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing-environment 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following elements: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. It should be noted that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

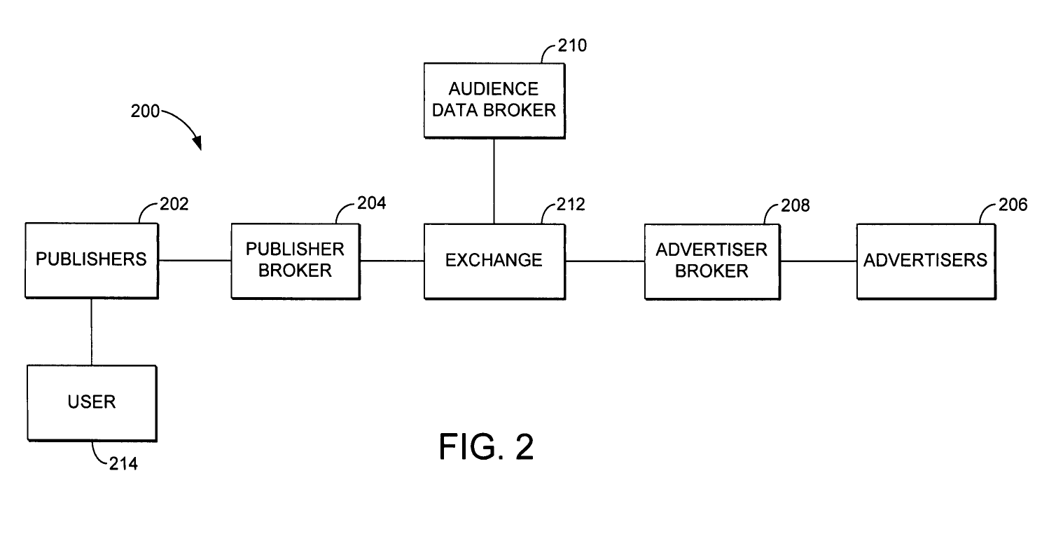

FIG. 2 illustrates a distributed architecture for online advertising, according to embodiments of the present invention. FIG. 2 illustrates architecture 200, which comprises publishers 202. For purposes of explanation only, publishers 202 will be discussed herein as a group of any number of publishers. However, embodiments of the present invention are not limited to a group of publishers, as a single publisher is sufficient. Also, embodiments of the present invention are not limited to a single group of publishers, as any number of groups of publishers may be present in architecture 200. In an embodiment each publisher is a content provider. For example, a construction worker who operates a single page website on which he posts a weblog (blog) may be a publisher. In another example, a media company such as Disney, who operates a huge website with many pages of content may also be a publisher. Publishers 202 is intended to represent any number of types, sizes, sophistication levels, etc. of publishers. In an embodiment, publishers 202 desire to sell advertisement space on their websites to advertisers 206 (discussed below).

Architecture 200 also comprises publisher broker 204. For purposes of explanation only, only one publisher broker will be discussed herein. However, embodiments of the present invention are not limited to a single publisher broker, as any number of publisher brokers may exist. In an embodiment, publisher broker 204 is an aggregator of publishers. Specifically, publisher broker 204 is an entity that represents publishers 202 with the goal of maximizing ad revenue, ensuring quality ads, etc. Publisher broker 204 breaks the conflict of interest that is inherent in systems such as Google's AdSense by solely focusing on managing publishers 202's yield. Publisher broker 204 allows small and mid-size publishers (such as those that may be represented by publishers 202) to aggregate in order to drive higher yield for themselves. In an embodiment, publisher broker 204 maintains a user interface through which it interacts with publishers 202 and through which it manages publishers 202's preferences.

In an embodiment, publisher broker 204 comprises a publisher center and a publisher delivery system. The publisher center allows publishers to manage their preferences. The publisher delivery system is used to calculate the ask for a given page view on the publisher's site, and potentially enrich the available user data in the request. In an embodiment, the ask is an asking price. However, embodiments are not so limited, as the ask may be, e.g., a minimum cost-per-click, minimum relevance, some other performance metric, etc. The publisher center establishes traffic inventory groupings in the system and sets asks. When a user makes a page request to the publisher, the publisher populates their page with some scripting that sets up a call to the publisher broker. The publisher may add in some information about the user to the call to the publisher broker (the incentive would be that more publishers would want to use a publisher broker that had this sort of value added service). The publisher broker determines what the ask should be for a particular request, given the user information present, the inventory grouping that the request falls into, and the rules the publisher has set up around that information. Additionally, the publisher broker will pass along the maximum amount that the publisher is willing to pay to have any unknown data attributes about the user populated for this request. Finally, the publisher broker encodes this information into a request URL that it sends back to the user as a redirection URL. When all transactions have occurred in the exchange (see below), a call back is provided to the publisher broker stating whether and how many ads were displayed, what the publisher broker can expect in terms of a payment, and which incremental attributes about the user were filled by an audience broker (see below).

Architecture 200 also comprises advertisers 206. For purposes of explanation only, advertisers 206 will be discussed herein as a group of any number of advertisers. However, embodiments of the present invention are not limited to a group of advertisers, as a single advertiser is sufficient. Also, embodiments of the present invention are not limited to a single group of advertisers, as any number of groups of advertisers may be present in architecture 200. In an embodiment each advertiser purchases ad space on websites. For example, a local businesswoman who operates a website for her small flower shop and who advertises on a neighborhood home owners' association website may be an advertiser. In another example, a massive corporate entity such as General Motors, which has thousands of products and services, and which advertises on thousands of automotive-related websites may also be an advertiser. Advertisers 206 is intended to represent any number of types, sizes, sophistication levels, etc. of advertisers. In an embodiment, advertisers 206 desire to pay money to place ads on publishers 202's websites.

Architecture 200 also comprises advertiser broker 208. For purposes of explanation only, only one advertiser broker will be discussed herein. However, embodiments of the present invention are not limited to a single advertiser broker, as any number of advertiser brokers may exist. In an embodiment, advertiser broker 208 is an aggregator of advertisers. Specifically, advertiser broker 208 is an entity that represents advertisers 206 with the goal of optimizing advertisers 206's spending and placing monetary values on displaying advertising of a particular format, on a particular website, to a particular audience. In an embodiment, advertiser broker 208 maintains a user interface through which it interacts with advertisers 206, and through which it manages advertisers 206's preferences, such as preferences for particular user data attributes. However, embodiments of the present invention are not limited to any particular advertiser preferences.

In an embodiment, an advertiser sets up ads in the advertiser broker system, but has no further interaction with the exchange (see below) or end user until such a point as the end user clicks on their ad. This means that the advertiser does not see any user attributes that have been populated by audience data brokers (see below) as part of the exchange transaction. In an embodiment, the exchange (see below) carries enough information to allow for advertisers to setup self-optimizing campaigns based only on landing URLs, creatives, and campaign goals. Similarly, algorithms can be run on advertiser landing URLs to choose possible subsets of audience attributes as well as relevant topics (keywords, categories, and content pages). The available features can then be selected to maximize the campaign goals, for example branding campaigns would minimize the amount paid per impression and maximize the coverage and inventory quality. A sales campaign on the other hand would be selected to track conversions and maximize the number of high value conversions for the existing advertiser budget.

Architecture 200 also comprises audience data broker 210. For purposes of explanation only, only one audience data broker will be discussed herein. However, embodiments of the present invention are not limited to a single audience data broker, as any number of audience data brokers may exist. In an embodiment, audience data broker 210 is an aggregator of user data providers. A user data provider is any entity that maintains any partial information that can be referred back to an individual user (such as one of users 214, discussed below) for advertising purposes. For example, user data may comprise demographic, psychographic, and behavioral information. More specifically, for example, user data may comprise age, gender, wealth index, interests, shopping habits, etc. However, embodiments of the present invention are not limited to any specific type of user data. In an embodiment, audience data broker 210 is any large user data aggregator, such as PayPal, Visa, Yahoo!, Verizon, as well as an aggregate of smaller user data providers. Any online store that collects user data can function as audience data broker 210 by providing user location level and user purchase pattern level information. This information can be aggregated with demographic profiles from small web email providers to form more comprehensive user descriptions.

In an embodiment, audience data broker 210 enriches information regarding a user viewing one of publishers 202's webpages. In an embodiment, audience data broker 210 does not disclose any personally identifiable information about the user. In an embodiment, audience data broker 210 accomplishes this by performing a private user ID lookup and passing back a set of aggregate user attributes that could be consumed by advertisers 206 and advertiser broker 208. This user attribute enrichment increases the value of the display of the ad to advertisers 206, helps produce more relevant ads to consumers, and creates a more complete picture of the user for ad serving purposes without violating the user's privacy. The aggregation across different providers serves two independent roles, in an embodiment: (1) it creates a comprehensive view of the audience landscape, and (2) it thickens the data sources to allow for anonymization and preservation of user privacy.

In an embodiment, audience data broker 210 receives direct payment for even small and/or partial user attributes. By participating in architecture 200, audience data broker 210: (1) is paid for its information, (2) can enrich its information (even redundant data providers are useful for scoring purposes), and (3) can verify its information (providers with poor quality of data will gain insight and will be able to actively address data quality issues). In an embodiment, audience data broker 210 receives a request from publisher broker 204 proxied by exchange 212 (explained in greater detail below). Audience data broker 210 appends known user attributes into this request for the consumption of advertiser broker 208. Audience data broker 210 does not know the page that the user is on from publisher broker 204, and audience data broker 210 will not pass any user identifiers to advertiser broker 208.

In an embodiment, audience data broker 210 comprises a user data recorder to record user information into the exchange (discussed below) and a user data delivery system to respond to requests for the user information. In an embodiment, the user data recorder informs the exchange that the audience data broker knows something about a user, through whatever means that may be. To do this, when the audience data broker has contact with a user that they know something about, the audience data broker can either set up a single pixel gif call to the exchange that the user will perform, or the audience data broker can redirect the current user request to the exchange, along with the information and a destination URL for the exchange to redirect the user to afterwards. In each case, whatever information or data key the audience data broker wishes to receive back is expected to be enough so that the audience data broker can answer user data delivery system requests for the use. In an embodiment, the information passed to the exchange is signed in a manner that proves the identity of the audience data broker to the exchange. In an embodiment, the exchange, upon verifying the identity of the audience data broker, will set a cookie to the user's browser with the name of the cookie identifying the audience data broker, and the cookie value being the information provided. In an embodiment, when the exchange receives an ad request from a user (the user having been sent to the exchange from a publisher broker), if there are any user data attributes that the publisher is willing to pay an additional amount for, then the cookies for all audience data brokers are read from the user's browser. For each audience data broker identified by a cookie, if the audience data broker is currently live, the exchange will send a request to that audience broker with the cookie value and any unknown data attributes which the publisher is willing to pay to have provided. The audience data broker then responds back, including the information for as many attributes as they know, along with the price they are asking for to allow it to be used.

In an embodiment, audience data brokers can participate in an advertiser auction and get paid directly through an advertiser bid with no audience data requests from the publisher broker. This would be considered a “publisher blind” audience data delivery. If an advertisement bid meets and exceeds a publisher requested minimum, then the bid remainder left after publisher ask can be used to acquire user data and maximize advertiser ROI (return on investment) using tighter targeting. The exchange provides a call back to the winning audience data broker(s) letting them know what attributes they won on, and what amount they will be paid for that information.

Given that publishers and advertisers can apply payments directly to audience data brokers for specific information, in an embodiment, there is a verification and rating process for audience data brokers. Multiple audience data brokers will be competing for the same service. In an embodiment, competition is performed based on ask, but also based on quality of data. Advertisers will have transparency into the publisher broker network, and similar transparency can be offered into the audience data broker network by offering a rating system. Audience data broker ratings can be calculated dynamically through the use of overlapping collection symbols. Overlapping data could be used to calculate ground truth predictions as well as verify the data provided by individual audience data brokers. This information in turn could be used to automatically rate audience data brokers. In an embodiment, a simple voting system can be used to verify the accuracy of any specific collection symbols for each broker, or the quality of the broker as a whole. The maintainers of the exchange would be responsible for publishing the voting consensus to the public, or to disbar the broker completely if necessary.

In an embodiment, no audience data broker will be able to provide ground truth data for all users. However, it might be possible to generate such data by creating data functions based on different providers and choosing the consensus opinion for each attribute. Publishers and advertisers could choose to use the consensus opinion or any individual audience data broker's collection symbols. In an embodiment, data units of “statistically significant” user data attributes could be created. Most audience data brokers often run into privacy issues not due to the data they have, but due to the data they don't know. Holes in a user profile could be significant or unique enough to be carrying sufficient information to reconstruct a unique user. Filling-in these holes using data from other user data providers could allow those providers to generate statistically significant aggregates that can be used for research purposes without sacrificing user privacy.

Architecture 200 also comprises exchange 212. Exchange 212 acts as a mediator among publisher broker 204, advertiser broker 208, and audience data broker 210. Exchange 212 is the framework that allows publisher broker 204 to have its ads enriched with additional user data by audience data broker 210. In an embodiment, exchange 212 routes traffic and facilitates transactions, e.g., auctions, between publisher broker 204, advertiser broker 208, and audience data broker 210. In an embodiment, exchange 212 is a server or a set of servers. Exchange 212 creates a system in which audience data broker 210 can monetize its data and in which advertiser broker 208 can reach a larger audience of more highly targetable traffic. In an embodiment, exchange 212 provides minimum standards of conformity, ensuring that some base information about the request is provided to be used by advertiser broker 208, regardless of population data from publisher broker 204 and audience data broker 210.

To provide minimum standards of conformity, in an embodiment, exchange 212 provides collection symbols related to the category of the publisher's page, the meaningful keywords in it, as well as geo-location information extracted from the user's IP address. The base data, such as the user IP address, the URL of the publisher's page, and any other such information deemed relevant should also be provided to each advertiser broker so that the advertiser broker may attempt to extract additional information to provide value-added services to the advertisers they service. In an embodiment, exchange 212 sends all publisher broker requests that match a set of criteria defined by the advertiser broker, along with all relevant data about the request (e.g., the ask and collection symbols provided by the publisher, audience broker, and the exchange itself). In an embodiment, if the advertiser broker has any ads that it would like to have displayed and that meet the ask, it returns those ads, up to the number of ads requested, along with a CPI (cost per impression) bid on each. However, embodiments are not limited to CPI pricing, as other pricing models may be used, e.g., CPC (cost per click), CPA (cost per acquisition), CPM (cost per thousand impressions), and revenue sharing. Exchange 212 provides a call back to the winning advertiser broker(s) telling it which ads were displayed, and at what prices.

Architecture 200 also comprises users 214. For purposes of explanation only, only one user will be discussed herein. However, embodiments of the present invention are not limited to a single user, as any number of users may exist. Users 214 request a webpage from publishers 202. The webpage comprises content and advertisement space, which is filled with advertisement(s) from advertisers 206.

Using architecture 200, audience data can be provided to advertisers 206 either by enriching the publishing property with customer intelligence or by acquiring the data directly from audience data broker 210 on the basis of a licensing fee. Advertiser broker 208 can choose to pay an estimated monthly per volume amount for each attribute that their advertisers are interested in targeting. This transaction could be done off-line but would need to be registered with exchange 212 to facilitate data rerouting at request time. Advertiser broker 208 can base its bids on any targeting attributes provided by audience data broker 210. For example, advertisers 206 may place base bids either on a CPC or CPM basis and have the option to incrementally bid for any attribute values exposed to them. Advertiser broker 208 is free to pay higher rates for redundancy or higher data quality. Advertiser broker 208 may manage the risk surrounding assessing individual advertiser performance and converting all bid types to CPI for final ranking by exchange 212. In an embodiment, the pricing model is similar to the pricing models discussed above.

In an embodiment, when publishers 202 have an impression that they are willing to sell (with an optional ask), they can provide a URL and any targetable values to exchange 212. Exchange 212 passes this data and possible additional user data from audience data broker 210 to advertiser broker 208. In an embodiment, advertiser broker 208 ranks the bids of advertisers 206 using any proprietary attributes or techniques that it finds useful. For example, advertiser broker 208 could choose to run keyword extraction or categorization and use this for targeting. Advertiser broker 208 would output a CPI ranked list of advertisers (in an embodiment, the number would be equal to the number of ads requested by the publisher), where the CPI value would already be stripped of any costs used for purchasing audience data. In an embodiment, where multiple advertiser brokers exist, exchange 212 then ranks all ads across all advertiser brokers and chooses the best one (as measured by CPI). If these ads meet or exceed the publisher ask, then exchange 212 proxies a display of the ads on the publisher website.

A second-price auction can still be applied to facilitate aggressive bidding. Publishers 202 can get paid on a CPI basis. Ad impressions are logged to be used for traffic volume calculations used for audience data licensing. In an embodiment, exchange 212 may be used to gate user information originating from publishers 202. Publishers 202 can choose to enrich their property with user data and share this information only with selected advertiser brokers.

To facilitate participants of all types to become part of architecture 200, it may be desirable to establish a pricing model that is extremely flexible, yet at the same time does not change the industry paradigm so greatly as to create confusion that would prevent potential participants from joining architecture 200. Advertisers are already accustomed to both CPC and CPM pricing, with a small but increasing market for CPA (cost per acquisition) pricing. Publishers tend to prefer CPM pricing, and the larger, more complex publishers sell traffic broken down by user demographics and in other ways. Smaller publishers generally have to accept what they can get, which often results in CPC or CPA pricing. Profile owners, such as audience data brokers, have not typically been able to capitalize on their data, and when they have, have done so in flat transactions for aggregate data.

To support the flexibility of all of these pricing models, and even to allow for others in the future, in an embodiment, exchange 212 is based on a CPI model between publisher broker 204 and advertiser broker 208, where, on each request, publisher broker 204 will set a minimum ask, i.e., reserve price, for their available ad space, and advertiser broker 208 will place a bid on the right to have their ads displayed on this request. As discussed above, embodiments are not limited to CPI pricing only. Exchange 212 will take a small portion of the revenue flowing through it to support its operations, which can either be implemented via incrementing the publisher ask by some percentage, or by making agreements with publishers 202 that some percentage of the revenue generated from their traffic will be held back.

Because publishers 202 are concerned with user satisfaction, they would prefer to have some control over the relevancy of the ads placed on their site. Click-through rate is considered a good measure of relevance and therefore many publishers might want minimum click-through guarantees on the ads. Exchange 212 allows publishers 202 to optionally specify a minimum click-through rate that is acceptable. Exchange 212 monitors advertiser broker 208 to make sure that if it wins these types of asks, then it is meeting the performance guarantees. In an embodiment, if an advertiser broker consistently provides low click-through rates for publisher asks that require a minimum, exchange 212 may take punitive measures such as suspension from the system.

Advertiser broker 208 is responsible for converting any externally facing pricing models it allows into the CPI bid on each request. For example, a simple CPC to CPI conversion would be to multiply the per click bid of each ad by the expected click through rate of the ad for the conditions present. Similarly, to convert a CPA bid to CPI, advertiser broker 208 could multiply the conversion rate by the per conversion bid of the advertiser. The more information available in each request, the better job advertiser broker 208 can potentially do in predicting the probability of a click or a conversion. Since it is expected that advertiser broker 208 will therefore desire additional information along with each request to help it predict what those probabilities are, as well as to allow the advertiser to express a preference for one or another of those attribute values by bidding differently, they will want to have information from audience data broker 210 at request time. The pricing model between audience data broker 210 and advertiser broker 208 will be a market, where audience data broker 210 sets minimum guarantee asks, as well as CPM pricing rates. In an embodiment, advertiser broker 208, if it wishes to use audience data broker 210's information, will agree to pay the greater of the guarantee amount or the CPM rate for the number of ad impression auctions that it wins. Exchange 212 is necessary to this transaction so as to track the number of ad impression auctions advertiser broker 208 wins, as well as to query for an attach audience data broker 210's user information to the request sent to advertiser broker 208.

The entity hosting exchange 212 has access to all data sources, giving it the power to make partial decisions. To alleviate the concern that exchange 212 will not be impartial both as hosting body and as a direct participant, in an embodiment, transparency will be built into exchange 212. In that embodiment, exchange 212 does not have a way to identify brokers of any kind. Also, in that embodiment, advertiser auction algorithms and advertiser to publisher and audience data broker matching algorithms are standardized and transparent to all exchange participants. In an embodiment, no user identifiable information is sent to advertisers 206 until the user performs an action. Exchange 212 passes advertiser broker 208 only the attribute values. Advertisers 206 do not see the user identifier. At click-time, however, it is still possible for an advertiser to establish a user identifier and associate the bidding profile with that user. By participating in architecture 200, audience data broker 210 is explicitly sharing its information with advertiser broker 208. Although some leakage is inevitable whenever targeting is permitted (e.g., if a user is targeted and clicks on an ad, the advertiser can correlate and store the targeting attributes for that user), providing audience data from every ask to advertiser broker 208 for bidding purposes exacerbates the problem. However, this can be addressed by centralizing the auction system at the exchange level by requiring that advertiser broker 208 specifies a value function that is evaluated for each ask on exchange 212. For example, exchange 212 could require a linear value function, and advertisers 206 would specify a base bid and a bid increment for each attribute value. Exchange 212 would control the instantiation of the audience data, thus not leaking any to advertiser broker 208.

In one example, Expedia as an advertiser has an ad for “cheap vacations in Bali.” Expedia chooses the keyword “Bali vacations.” Business intelligence suggests that the best way to target vacation ads is around users who have a history of purchasing vacations, users who recently have purchased books on vacations and users who perform searches related to travel. Expedia decides to license user information from Amazon, MSNSearch, and Orbitz. Expedia agrees to pay Amazon 1 cent for using their user information for each ad impression. Similarly, Expedia agrees to pay 1 cent to MSNSearch and 3 cents to Orbitz.

For the “cheap Bali vacations” ad, Expedia creates a targeting profile for users who: “bought a book on Bali in the last month,” “Have traveled to a tropical location in the last two years,” “Have household income between $30,000 and $60,000,” “Have been searching for vacation deals,” and “Have ever clicked on ads.” Expedia places a 20 cent base bid. To express their bidding preference, they also place a 5 cent incremental bid for the first attribute, a 10 cent incremental bid for the second attribute, a 2 cent incremental bid for the third attribute, 1 cent incremental bid for the fourth attribute, and a 2 cent incremental bid for the fifth attribute to express their bidding preference. Additionally, exchange 212 will log all views where user data was used to enrich targeting and help audience data broker 210 enforce the licensing fees. Borders as a publisher has a user requesting the page on the “Lonely Planet Guide to Indonesia” and they would like to show ads on that page. They call exchange 212 with the page URL and information about the user: “Bought four travel books in the last month,” “Bought a book on Bali in the last month,” and “Has clicked on ads before.”

Given the URL, exchange 212 extracts keywords (“Bali vacations,” “Indonesia travel,” “exotic vacations,” “beach vacations”), categories (“travel,” “vacations”) and proxied user data information (coming from the licenses with audience data broker 210), and sends this information to each advertiser broker. Each advertiser runs an auction for the impression. The advertiser broker can choose to ask for aggregate bids from advertisers and subtract the audience data broker licensing fees at the time of the impression. For example, Expedia might place an aggregate bid of 24 cents, and after subtracting the licensing fees, their base bid would be equal to 20 cents. Expedia's advertiser broker needs first to subtract all incremental bids and to assign credit to the publisher or audience data broker as appropriate. For example, Expedia's 5 cent incremental bid for “bought a book on Bali in the last month” and their 2 cent incremental bid for “Have ever clicked on ads” will be assigned to the publisher. The value for “Have traveled to a tropical location in the last two years” attribute is provided by Orbitz so the 10 cent incremental bit would be assigned to them. Neither the publisher, nor the audience data brokers were able to assess the household income of the user so this incremental bid is not used. The 1 cent incremental bid for the search user patterns will be credited to MSNSearch. After the appropriate credit distribution the advertiser broker would assign a publisher value bid (the base bid+any incremental publisher bids) to each advertiser. In case of Expedia publisher value bid would be equal to 27 cents. Given that Expedia's bid is CPC based, the advertiser broker needs to convert it to a CPI one before running an auction and selecting the best ads to send to the exchange. Expedia's advertiser broker knows that this specific ad is likely to get a 10% CTR, and thus for ranking purposes, Expedia is assigned a 2.7 cent CPI bid. If Expedia wins within its advertiser broker, its ad will be sent for global ranking to the exchange. If Expedia wins the global auction then their advertiser broker is charged 2.7 cents for displaying the Expedia ad. Expedia's ad gets served on Border's page. The user clicks on the ad. The user buys a two-week vacation to Bali.

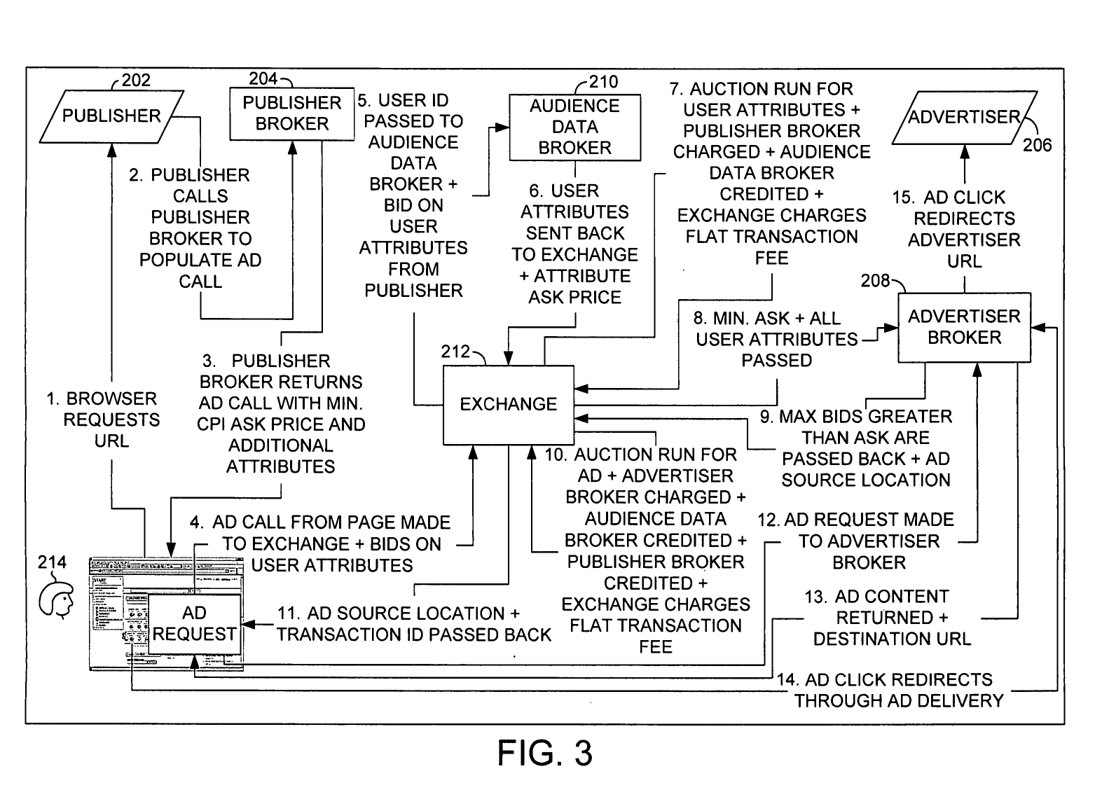

FIG. 3 illustrates one example of the flow of data within architecture 200, according to embodiments of the present invention. Referring to FIG. 3, user 214 opens a browser and requests a URL of a webpage from publisher 202 (1). In an embodiment, the webpage has some advertisement space available, which publisher 202 desires to sell to an advertiser. Publisher 202 calls publisher broker 204 to populate the ad call (2). Publisher broker 204 returns the ad call with a minimum CPI ask price and additional attributes (as discussed in greater detail above) (3). The ad call is made to exchange 212 along with bids on user attributes and a user identifier (4). Exchange 212 passes the user identifier and the bid on attributes to audience data broker 210 (5). In an embodiment, audience data broker identifiers are stored on the user-side and are sent with the ad call to exchange 212 so that exchange 212 can identify which audience data broker(s) may have information about the user. Audience data broker 210 looks up the user identifier and responds with the corresponding attributes along with an attribute ask price (6). In an embodiment, exchange 212 runs an auction for the user attributes, charges publisher broker 204, credits audience data broker 210, and holds back a flat transaction fee (7). Exchange 212 passes a minimum ask plus all user attributes to advertiser broker 208 (8). Advertiser broker 208 responds with all of the bids that are greater than the ask, along with the ad source location (9). In an embodiment, exchange 212 runs an auction for the ad, charges advertiser broker 208, credits audience data broker 210 and publisher broker 204, and holds back a flat transaction fee (10). Exchange 212 passes the ad source location and transaction identifier back (11). An ad request is made to advertiser broker 208 (12), which responds with the ad content and a destination URL (13). If user 214 clicks on the ad, the user is redirected by advertiser broker 208 (14) to advertiser 206 (15). The above example illustrates just one embodiment of the present invention. Other embodiments may not involve the same operations or conduct them in the same order. Specifically, other examples may not supplement with data from audience data broker 210. Other examples may not rely on auctions to set prices, instead relying on a firm ask that can be accepted or declined.

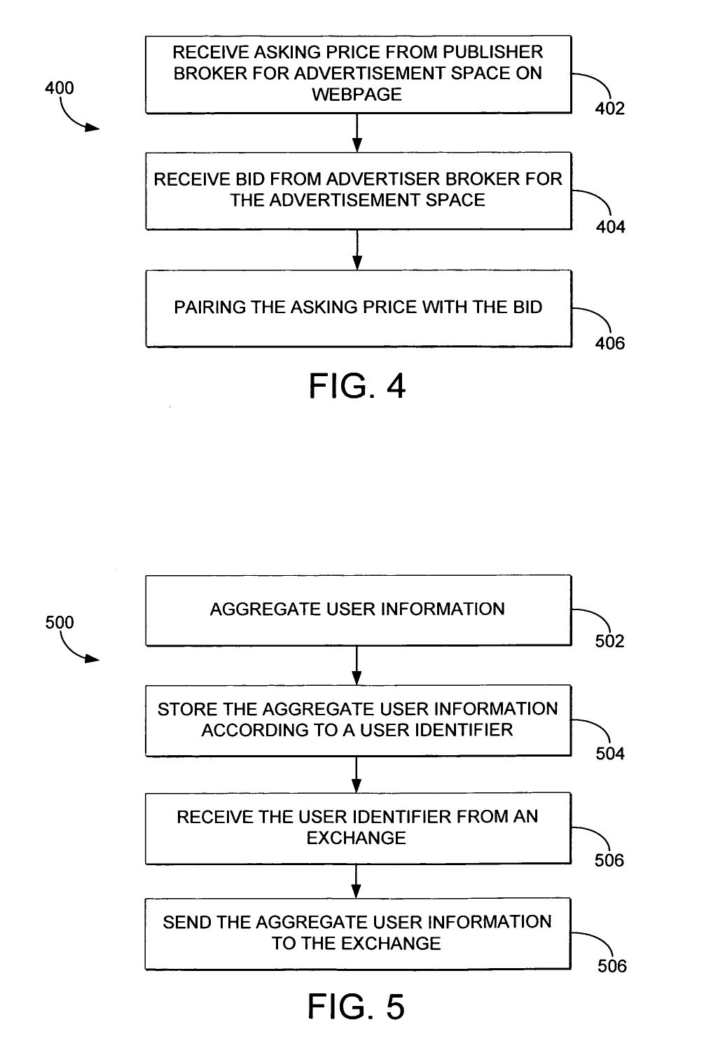

FIG. 4 illustrates a flowchart of the operation of an exchange, according to embodiments of the present invention. Referring to FIG. 4, method 400 begins with the receipt of an ask from a publisher broker for advertisement space on a webpage (402). A bid is received from an advertiser broker for the advertisement space (404). In an embodiment, bids are received from many different advertiser brokers. The ask is paired with one of the bids (406) and the advertisement space on the webpage is awarded to the winning bidder. As discussed in greater detail above, other information such as user attributes may be attached to the ask, and quality of the bidding advertisers may be examined prior to the advertisement space being awarded.

FIG. 5 illustrates a flowchart of the operation of an audience data broker, according to embodiments of the present invention. Referring to FIG. 5, method 500 begins with the aggregation of user information (502). The aggregate user information is stored according to a user identifier (504). When the user identifier is received from an exchange (506), the aggregate user information corresponding to that user identifier is sent to the exchange (508). In an embodiment, the audience data broker may set a cookie on the user computer to identify itself as having information about that user. When the exchange reads that cookie, it knows which audience data brokers to query for information about the user.

A system to facilitate trading of advertising comprises: a publisher broker to represent at least one publisher, wherein the publisher broker determines an ask for an advertisement space on the at least one publisher's webpage; an advertiser broker to represent at least one advertiser, wherein the advertiser broker manages an advertiser's bid for the advertisement space; and an exchange to facilitate a transaction for the advertisement space between the publisher broker and the advertiser broker.

A method of facilitating trading of advertising comprises: receiving an ask from a publisher broker for an advertisement space on a webpage, wherein the publisher broker represents a publisher that received a request for the webpage from a user; receiving a bid from an advertiser broker for the advertisement space, wherein the advertiser broker represents an advertiser who desires to advertise to the user; and pairing the ask with the bid, wherein the user receives the webpage from the publisher with an advertisement from the advertiser in the advertisement space.

A method for enriching user information comprises: aggregating user information about a user; storing the aggregate user information according to a user identifier; receiving the user identifier from an exchange; and sending the aggregate user information to the exchange.

Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

The invention claimed is:

1. A system to facilitate trading of advertising, comprising:
a publisher broker to represent at least one publisher, wherein the publisher broker determines an ask for an advertisement space on the at least one publisher's webpage;
an advertiser broker to represent at least one advertiser, wherein the advertiser broker manages one of the at least one advertiser's bid for the advertisement space; and
an exchange to facilitate a transaction for the advertisement space between the publisher broker and the advertiser broker.

2. The system of claim 1, further comprising:
an audience data broker to represent at least one user data owner, wherein the audience data broker aggregates user information, associates the aggregate user information with a user identifier, and provides the aggregate user information to the exchange.

3. The system of claim 2, wherein the exchange facilitates a transaction for the aggregate user information.

4. The system of claim 2, wherein the aggregate user information is appended to the ask.

5. The system of claim 2, wherein the audience data broker sets a cookie on the user's computer.

6. The system of claim 5, wherein the audience data broker has an identifier associated therewith that is stored in the cookie.

7. The system of claim 1, wherein the advertiser broker manages advertisements.

8. The system of claim 1, wherein the publisher establishes a traffic inventory grouping and sets the ask via the publisher broker.

9. The system of claim 1, wherein the exchange provides information about the publisher's webpage to the advertiser broker.

10. The system of claim 1, wherein the transaction for the advertisement space is based upon a cost-per-impression, cost-per-acquisition, cost-per-click, cost-per-thousand-impressions, or revenue sharing pricing model.

11. A method of facilitating trading of advertising, comprising:
receiving an ask from a publisher broker for an advertisement space on a webpage, wherein the publisher broker represents a publisher that received a request for the webpage from a user;
receiving a bid from an advertiser broker for the advertisement space, wherein the advertiser broker represents an advertiser who desires to advertise to the user; and
pairing the ask with the bid, wherein the user receives the webpage from the publisher with an advertisement from the advertiser in the advertisement space.

12. The method of claim 11, further comprising:
receiving an audience data broker identifier from the user;
sending to an audience data broker a user identifier that identifies the user; and
receiving aggregate user information from an audience data broker that is associated with the user identifier.

13. The method of claim 12, further comprising:
facilitating a transaction for the aggregate user information.

14. The method of claim 12, further comprising:
appending the aggregate user information to the ask.

15. The system of claim 11, further comprising:
facilitating a transaction for the advertisement space between the publisher broker and the advertiser broker.

16. The system of claim 15, wherein the transaction for the advertisement space is based upon a cost-per-impression, cost-per-acquisition, cost-per-click, cost-per-thousand-impressions, or revenue sharing pricing model.

17. The system of claim 11, further comprising:
providing information about the webpage to the advertiser broker.

18. A method for enriching user information, comprising:
aggregating user information about a user;
storing the aggregate user information according to a user identifier;
receiving the user identifier from an exchange; and
sending the aggregate user information to the exchange.

19. The method of claim 18, further comprising:
setting a cookie on the user's computer.

20. The method of claim 18, further comprising:
receiving an attribute from the exchange,
wherein the aggregate user information that is sent to the exchange is related to the attribute.
